(19) United States
(12) Patent Application Publication
(10) Pub. No.: US 2026/0193933 A1
(43) Pub. Date: Jul. 9, 2026

(54) WELDED FENESTRATION UNIT FRAME WITH ENHANCED PERFORMANCE

(71) Applicant: Andersen Corporation, Bayport, MN (US)

(72) Inventors: Ross McGruder, Lake Elmo, MN (US); Matthew Wilson, Woodbury, MN (US); Ryan Mohs, Woodbury, MN (US); Jeffrey Skeels, Oakdale, MN (US); Claire Swank, Minneapolis, MN (US); Micah Thorson, North Branch, MN (US)

(21) Appl. No.: 19/435,916

(22) Filed: Dec. 30, 2025

Related U.S. Application Data
(60) Provisional application No. 63/742,166, filed on Jan. 6, 2025.

(51) Int. Cl. E06B 3/96; E06B 7/14

(52) U.S. Cl. CPC E06B 3/9632; E06B 3/9608; E06B 7/14

(57) ABSTRACT

Welded fenestration unit frames with enhanced water penetration and air infiltration performance and related methods are described herein. The welded fenestration unit frames include a 2-piece sill design including a sill member welded to side jambs and a separate sill stop attached to the sill member and side jambs. The fenestration unit frames may also include primary and secondary water containment and drainage features.

### RELATED APPLICATION

The present application claims the benefit under 35 U.S.C. § 119(e) of U.S. Provisional Patent Application 63/742,166 filed on Jan. 6, 2025, and titled WELDED FENESTRATION UNIT FRAME WITH ENHANCED PERFORMANCE, which is hereby incorporated by reference in its entirety.

Welded fenestration unit frames with enhanced performance along with related methods are described herein.

Water management features and systems are provided in some fenestration unit sills to contain and drain water collected in the sills during storms or other water events. Although designed to contain and drain water, some sills struggle to adequately handle larger volume events.

Water management is further complicated when fenestration unit frames are designed to be welded at the corners between, e.g., sills and side jambs. Welding equipment and/or processes may be complicated and/or the water management may be achieved using techniques such as, e.g., butt joints, etc. that are welded or sealed in ways that are often aesthetically undesirable and/or destined to fail over time.

### SUMMARY

Welded fenestration unit frames with enhanced performance and related methods are described herein.

In one or more embodiments, the unique sill member and side jamb profile designs enable the shapes to be enhanced for the unique functional requirements of a sill member versus the side jambs in a fenestration unit frame. The dissimilar profiles are strategically designed with certain shared/corresponding internal and external walls that allow for strong welds at the corners of the fenestration unit frames that may also enhance water containment and drainage.

In one or more embodiments, the shared/corresponding internal and external walls of the sill members and side jambs of the fenestration unit frames described herein create a continuous and effective seal in the mitered and welded frame joints between the side jambs and the sill members of fenestration unit frame as described herein. When those welded joint seals are coupled with the seals between the sill stops and the sill members/side jambs, the fenestration unit frames provide robust protection against water penetration and/or air infiltration.

The addition of a separate sill stop enhances control over water by providing a barrier to passage of water and air to an interior side of the fenestration unit frame. The sill stops avoid the welding equipment and/or sealing processes that typical welded fenestration unit frames that employ, e.g., welded and/or sealed butt joints, etc. in an attempt to provide water and air management that are aesthetically undesirable and/or destined to fail over time.

The side jambs of the fenestration unit frames described herein are fabricated (before or after the corner joints between the sill member and the side jambs are welded) such that the side jambs include a notch (or pocket) to house the end portions of a sill stop attached to the sill member. In one or more embodiments, the notches in the side jambs are fabricated to expose notch faces, with the sill stop extending past the ends of the sill members and across the welds between the sill members ends and the side jamb ends into the notches in the side jambs.

The exposed notch faces in the side jambs and an interior face of the sill member preferably provide a generally co-planar surface that presents a continuous, sealed, flat plane that extends up the side jambs to the height of the sill stop across the length of the sill. In one or more embodiments, a seal is provided between the interior face of the sill member and the exposed notch faces of the side jambs to limit and preferably prevent water penetration and/or air infiltration through the interfaces between the sill stops and each of the sill members and exposed notch faces of the notches of the side jambs in the fenestration unit frames described herein.

In one or more embodiments, the sill stop has a depth along an interior/exterior axis of the fenestration unit frame and the notches in the side jambs have depths along that same axis that are substantially equivalent such that an interior face of the sill stop sits flush with the interior faces of the side jambs for a clean, aesthetically pleasing interior appearance that also provides robust protection from water penetration and/or air infiltration.

Another advantage of the two-piece sill design of the fenestration unit frames described herein is the ability to select the Performance Grade (PG) rating for the fenestration unit frame by changing the height of the sill stop and notches in the side jambs. Increasing the heights of the sill stop and side jamb notches increases the water column height that can be contained by the two-piece sill (assuming the same lower/bottom location on the sill member). This adjustability allows for a selected balance between PG rating and other design considerations such as increasing/maximizing egress. This scalability allows for nimble evolution of window performance to meet changing market needs and/or to increase performance robustness against a marketed PG rating. This flexibility can be achieved without requiring significant changes in the design of the sill member and/or side jambs.

In one or more embodiments, the shared/corresponding internal and external walls between the sill members and the side jambs that allow for strong welds at the corners of the fenestration unit frames may also be selected to provide both a primary containment tank and a secondary containment tank that may enhance water containment and drainage of the fenestration unit frames described herein. In one or more embodiments, the sill members include one or more troughs and one or more trough drains that allow for drainage of water from the troughs into the primary containment tanks, as well as one or more primary exterior drains through which water passes out of the primary containment tanks. Containment tanks, trough drains, exterior drains can be found in known “contain and drain” sill systems such as those described in, e.g., U.S. Pat. No. 9,863,183 (Johnson et al.) and US Patent Publication No. 2024/0254819 (Rietz et al.).

While such primary containment tanks along with their related features are known, the sill members of the fenestration unit frame described herein also form, along with the side jamb members, secondary containment tanks are also provided in the sill members to drain water entering the sill members through junctions between the upper edges of the sill members and the side jambs at the fenestration unit frame corners. In one or more embodiments of the fenestration unit frames described herein, it can be difficult or impossible to weld the sill members to the side jambs at those exterior sill-side jamb junctions to provide a water-tight junction that is also aesthetically acceptable. Water passing through those exterior sill-side jamb junctions can, in one or more embodiments of the fenestration unit frames described herein, can be collected in secondary containment tanks in the sill members and drained to the exterior side of the fenestration unit frames. In one or more embodiments, the primary containment tanks and secondary containment tanks are fluidically isolated from each other within the sill members to, e.g., allow for independent water management between the primary and secondary containment tanks.

Water collected in the secondary containment tanks can, in one or more embodiments, escape freely from “exterior to exterior” of the fenestration unit frames described herein without ever entering the primary containment tanks wherein the additional water and/or air could potentially increase air leakage through the fenestration unit or contribute to overwhelming the drainage capacity of the primary containment tanks.

In one or more embodiments, the welded fenestration unit frames described herein include a 2-piece sill design including a sill member notch-welded to side jambs and a separate sill stop attached to the sill member and side jambs. In one or more embodiments, the sill member can be notch-welded to dissimilar side jamb members using less specialized equipment than notch fabrication designs used in typical vinyl or other welded fenestration unit frames. It should be understood that whether notch-welded or not, the welded portions of the corner joints are between mitered faces on the sill members and side jambs of fenestration unit frames as described herein. Other portions of the sill member and/or side jambs may not be mitered and it is those non-mitered non-welded portions that form the basis for the term “notch-welded” as used in connection with fenestration unit frames as described herein.

In a first aspect, one or more embodiments of a fenestration unit frame of a fenestration unit as described herein includes: a sill member comprising a first sill end and a second sill end, wherein a sill axis extends between the first sill end and the second sill end, wherein the sill member comprises an interior sill face proximate an interior side of the fenestration unit frame and an exterior sill face on an exterior side of the fenestration unit frame, wherein the interior sill face and the exterior sill face are separated from each over a depth of the fenestration unit frame along an interior/exterior axis of the fenestration unit frame; a first side jamb comprising a first side jamb end attached to the first sill end at a first mitered frame joint, wherein the first side jamb comprises a first side jamb interior face and a first side jamb exterior face, wherein the first side jamb interior face and the first side jamb exterior face are separated from each along the interior/exterior axis, and wherein the first mitered frame joint comprises a welded joint between the first side jamb end and the first sill end; a second side jamb comprising a second side jamb end attached to the second sill end at a second mitered frame joint, wherein the second side jamb comprises a second side jamb interior face and a second side jamb exterior face, wherein the second side jamb interior face and the second side jamb exterior face are separated from each along the interior/exterior axis, and wherein the second mitered frame joint comprises a welded joint between the second side jamb end and the second sill end; a sill stop attached to the interior face of the sill member, the sill stop comprising an upper edge and a lower edge extending between the first side jamb and the second side jamb, wherein the upper edge of the sill stop is aligned with the sill axis and located above a top edge of the sill member between the first side jamb and the second side jamb, and wherein the lower edge of the sill stop is located below the top edge of the sill member between the first side jamb and the second side jamb such that the sill stop forms a dam above the sill member between the first side jamb and the second side jamb; a first jamb notch formed into the first side jamb interior face proximate the first side jamb end, wherein the first jamb notch comprises a first exposed notch face located between a first notch top edge and the first side jamb end, wherein the first exposed notch face is inset from the first side jamb interior face, and wherein a first end portion of the sill stop occupies the first jamb notch such that the upper edge of the sill stop faces the top edge of the first jamb notch; and a second jamb notch formed into the second side jamb interior face proximate the second side jamb end, wherein the second jamb notch comprises a second exposed notch face located between a second notch top edge and the second side jamb end, wherein the second exposed notch face is inset from the second side jamb interior face, and wherein a second end portion of the sill stop occupies the second jamb notch such that the upper edge of the sill stop faces the top edge of the second jamb notch.

In one or more embodiments of a fenestration unit frame as described herein, the first end portion of the sill stop covers at least a portion of an interior edge of the first mitered frame joint, and the second end portion of the sill stop covers at least a portion of an interior edge of the second mitered frame joint.

In one or more embodiments of a fenestration unit frame as described herein, the first end portion of the sill stop covers an interior edge of the first mitered frame joint from an inside corner of the first mitered frame joint to an outside corner of the first mitered frame joint, and the second end portion of the sill stop covers an interior edge of the second mitered frame joint from an inside corner of the second mitered frame joint to an outside corner of the second mitered frame joint.

In one or more embodiments of a fenestration unit frame as described herein, the upper edge of the sill stop is aligned with the top edge of the first jamb notch.

In one or more embodiments of a fenestration unit frame as described herein, the upper edge of the sill stop is aligned with the top edge of the second jamb notch.

In one or more embodiments of a fenestration unit frame as described herein, the sill stop comprises a sill stop interior face facing away from the sill member, wherein the sill stop interior face, the first side jamb interior face, and the second side jamb interior face are all coplanar with each other on the interior side of the fenestration unit frame.

In one or more embodiments of a fenestration unit frame as described herein, the first end portion of the sill stop covers the first exposed notch face of the first side jamb between the top edge of the first jamb notch and the interior edge of the first mitered frame joint; and the second end portion of the sill stop covers the second exposed notch face of the second side jamb between the top edge of the second jamb notch and the interior edge of the second mitered frame joint.

In one or more embodiments of a fenestration unit frame as described herein, the fenestration unit frame comprises a seal located between the sill stop and the interior sill face, wherein a first end section of the seal is located between the first end portion of the sill stop and the first exposed notch face in the first notch of the first side jamb, and wherein a second end section of the seal is located between the second end portion of the sill stop and the second exposed notch face in the second notch of the second side jamb. In one or more embodiments, the first end section of the seal extends across the interior edge of the first mitered frame joint and wherein the second end section of the seal extends across the interior edge of the second mitered frame joint.

In one or more embodiments of a fenestration unit frame including a seal located between the sill stop and the interior sill face as described herein, the first end section of the seal is located above the top edge of the sill member in the first exposed notch face of the first side jamb, and the second end section of the seal is located above the top edge of the sill member in the second exposed notch face of the second side jamb and the top edge of the sill member.

In one or more embodiments of a fenestration unit frame including a seal located between the sill stop and the interior sill face as described herein, the first end section of the seal comprises a first terminal seal end located closer to the upper edge of the sill stop than the bottom edge of the sill stop, and the second end section of the seal comprises a second terminal seal end located closer to the upper edge of the sill stop than the bottom edge of the sill stop.

In one or more embodiments of a fenestration unit frame including a seal located between the sill stop and the interior sill face as described herein, the seal extends continuously from a first end proximate the top edge of the first jamb notch to a second end proximate the top edge of the second jamb notch.

In one or more embodiments of a fenestration unit frame including a seal located between the sill stop and the interior sill face as described herein, the seal comprises a flowable material when the sill stop is attached to the sill member.

In one or more embodiments of a fenestration unit frame as described herein, the sill member comprises: a trough located between the interior sill face and the exterior sill face, the trough extending from the first sill end to the second sill end; a primary containment tank located in the sill member below the trough; a trough drain configured to drain water in the trough into the primary containment tank; a primary exterior drain in the sill member, the primary exterior drain configured to drain water in the primary containment tank to the exterior side of the fenestration unit frame; a secondary containment tank located in the sill member, the secondary containment tank located between the trough and the exterior sill face; and a secondary exterior drain in the sill member, the secondary exterior drain configured to drain water in the secondary containment tank to the exterior side of the fenestration unit frame.

In one or more embodiments of a fenestration unit frame in which the sill member comprises a primary containment tank and a secondary containment tank as described herein, the primary containment tank and the secondary containment tank are fluidically isolated from each other within the sill member.

In one or more embodiments of a fenestration unit frame in which the sill member comprises a primary containment tank and a secondary containment tank as described herein, the secondary containment tank is located above the primary containment tank in the sill member.

In one or more embodiments of a fenestration unit frame in which the sill member comprises a primary containment tank and a secondary containment tank as described herein, the secondary exterior drain is located above the primary exterior drain.

In one or more embodiments of a fenestration unit frame in which the sill member comprises a primary containment tank and a secondary containment tank as described herein, the sill member comprises an upper exterior surface located between the trough and the exterior face of the sill member, wherein the upper exterior surface of the sill member meets the first side jamb proximate the first sill end at a first exterior sill-side jamb junction, wherein the upper exterior surface of the sill member meets the second side jamb proximate the second sill end at a second exterior sill-side jamb junction, wherein water passing through the first exterior sill-side jamb junction enters the secondary containment tank, and wherein water passing through the second exterior sill-side jamb junction enters the secondary containment tank.

In a second aspect, one or more embodiments of a method of constructing a fenestration unit frame as described herein includes: welding a first sill end of a sill member to a first side jamb end of a first side jamb to form a first mitered frame joint at a first corner of the fenestration unit frame; welding a second sill end of the sill member to a second side jamb end of a second side jamb to form a second mitered frame joint at a second corner of the fenestration unit frame; removing a first notch portion of the first side jamb from the first side jamb, wherein the removing forms a first jamb notch in a first side jamb interior face of the first side jamb proximate the first side jamb end, wherein the first jamb notch comprises a first exposed notch face located between a first notch top edge and the first side jamb end, wherein the first exposed notch face is inset from the first side jamb interior face; removing a second notch portion of the second side jamb from the second side jamb, wherein the removing forms a second jamb notch in a second side jamb interior face of the second side jamb proximate the second side jamb end, wherein the second jamb notch comprises a second exposed notch face located between a second notch top edge and the second side jamb end, wherein the second exposed notch face is inset from the second side jamb interior face; and attaching a sill stop to the fenestration unit frame, wherein the sill stop is positioned over an interior sill face of the sill member such that a first end portion of the sill stop is located over the first exposed notch face of the first jamb notch and a second end portion of the sill stop is located over the second exposed notch face of the second jamb notch.

In one or more embodiments of a method of constructing a fenestration unit frame as described herein, the removing the first notch portion comprises removing the first notch portion before welding the first sill end of the sill member to the first side jamb end of the first side jamb to form the first mitered frame joint.

In one or more embodiments of a method of constructing a fenestration unit frame as described herein, the removing the first notch portion comprises removing the first notch portion after welding the first sill end of the sill member to the first side jamb end of the first side jamb to form the first mitered frame joint.

In one or more embodiments of a method of constructing a fenestration unit frame as described herein, the sill stop comprises an upper edge located above a top edge of the sill member, and, after attaching the sill stop to the fenestration unit frame, the upper edge of the sill stop in the first end portion of the sill stop faces the top edge of the first jamb notch and the upper edge of the sill stop in the second end portion of the sill stop faces the top edge of the second jamb notch.

In one or more embodiments of a method of constructing a fenestration unit frame as described herein, after attaching the sill stop to the fenestration unit frame, the upper edge of the sill stop is aligned with the top edge of the first jamb notch.

In one or more embodiments of a method of constructing a fenestration unit frame as described herein, after attaching the sill stop to the fenestration unit frame, the upper edge of the sill stop is aligned with the top edge of the second jamb notch.

In one or more embodiments of a method of constructing a fenestration unit frame as described herein, after attaching the sill stop to the fenestration unit frame, the first end portion of the sill stop covers at least a portion of an interior edge of the first mitered frame joint in the first exposed notch face, and the second end portion of the sill stop is located in the second jamb notch and covers at least a portion of an interior edge of the second mitered frame joint in the second exposed notch face. In one or more embodiments, the first end portion of the sill stop covers the interior edge of the first mitered frame joint from an inside corner of the first mitered frame joint to an outside corner of the first mitered frame joint, and the second end portion of the sill stop covers the interior edge of the second mitered frame joint from an inside corner of the second mitered frame joint to an outside corner of the second mitered frame joint.

In one or more embodiments of a method of constructing a fenestration unit frame as described herein, the sill stop comprises a sill stop interior face facing away from the sill member, and, after attaching the sill stop to the fenestration unit frame, the sill stop interior face, the first side jamb interior face, and the second side jamb interior face are all coplanar with each other on the interior side of the fenestration unit frame.

In one or more embodiments of a method of constructing a fenestration unit frame as described herein, the fenestration unit frame comprises a seal located between the sill stop and the interior sill face, wherein, after attaching the sill stop to the fenestration unit frame, a first end section of the seal is located between the first end portion of the sill stop and the first exposed notch face in the first notch of the first side jamb, and a second end section of the seal is located between the second end portion of the sill stop and the second exposed notch face in the second notch of the second side jamb.

In one or more embodiments of a method of constructing a fenestration unit frame including a seal located between the sill stop and the interior sill face as described herein, the first end section of the seal extends over an interior edge of the first mitered frame joint in the first exposed notch face and the second end section of the seal extends over an interior edge of the second mitered frame joint in the second exposed notch face.

In one or more embodiments of a method of constructing a fenestration unit frame including a seal located between the sill stop and the interior sill face as described herein, the first end section of the seal is located above the top edge of the sill member in the first exposed notch face of the first side jamb, and the second end section of the seal is located above the top edge of the sill member in the second exposed notch face of the second side jamb and the top edge of the sill member.

In one or more embodiments of a method of constructing a fenestration unit frame including a seal located between the sill stop and the interior sill face as described herein, the sill stop comprises an upper edge located above a top edge of the sill member, and the first end section of the seal comprises a first terminal seal end located closer to the upper edge of the sill stop than the bottom edge of the sill stop, and the second end section of the seal comprises a second terminal seal end located closer to the upper edge of the sill stop than the bottom edge of the sill stop.

In one or more embodiments of a method of constructing a fenestration unit frame including a seal located between the sill stop and the interior sill face as described herein, the seal extends continuously from a first terminal seal end proximate the top edge of the first jamb notch to a second terminal seal end proximate the top edge of the second jamb notch.

In one or more embodiments of a method of constructing a fenestration unit frame including a seal located between the sill stop and the interior sill face as described herein, the seal comprises a flowable material and wherein the method comprises depositing at least a portion of the flowable material onto the sill stop before attaching the to the fenestration unit frame.

In one or more embodiments of a method of constructing a fenestration unit frame including a seal located between the sill stop and the interior sill face as described herein, the seal comprises a flowable material and wherein the method comprises depositing at least a portion of the flowable material onto the interior sill face, the first exposed notch face, and the second exposed notch face before attaching the sill stop to the fenestration unit frame.

In one or more embodiments of a method of constructing a fenestration unit frame as described herein, the sill member comprises: a trough located between the interior sill face and an exterior sill face on an exterior side of the fenestration unit frame, wherein the interior sill face and the exterior sill face are separated from each over a depth of the fenestration unit frame along an interior/exterior axis of the fenestration unit frame, the trough extending from the first sill end to the second sill end; a primary containment tank located in the sill member below the trough; a trough drain configured to drain water in the trough into the primary containment tank; a primary exterior drain in the sill member, the primary exterior drain configured to drain water in the primary containment tank to the exterior side of the fenestration unit frame; a secondary containment tank located in the sill member, the secondary containment tank located between the trough and the exterior sill face; and a secondary exterior drain in the sill member, the secondary exterior drain configured to drain water in the secondary containment tank to the exterior side of the fenestration unit frame; wherein welding the first sill end of the sill member to the first side jamb end of the first side jamb to form the first mitered frame joint at the first corner of the fenestration unit frame and welding the second sill end of the sill member to the second side jamb end of the second side jamb to form the second mitered frame joint at the second corner of the fenestration unit frame forms the primary containment tank and the secondary containment tank.

In one or more embodiments of a method of constructing a fenestration unit frame including a primary containment tank and a secondary containment tank in a sill member as described herein, the primary containment tank and the secondary containment tank are fluidically isolated from each other within the sill member.

In one or more embodiments of a method of constructing a fenestration unit frame including a primary containment tank and a secondary containment tank in a sill member as described herein, the secondary containment tank is located above the primary containment tank in the sill member.

In one or more embodiments of a method of constructing a fenestration unit frame including a primary containment tank and a secondary containment tank in a sill member as described herein, the secondary exterior drain is located above the primary exterior drain.

In one or more embodiments of a method of constructing a fenestration unit frame including a primary containment tank and a secondary containment tank in a sill member as described herein, the sill member comprises an upper exterior surface located between the trough and the exterior face of the sill member, wherein the upper exterior surface of the sill member meets the first side jamb proximate the first sill end at a first exterior sill-side jamb junction, wherein the upper exterior surface of the sill member meets the second side jamb proximate the second sill end at a second exterior sill-side jamb junction, wherein water passing through the first exterior sill-side jamb junction enters the secondary containment tank, and wherein water passing through the second exterior sill-side jamb junction enters the secondary containment tank.

Where used herein, the terms “exterior” and “interior” are used in a relative sense, for example, an exterior surface and an interior surface may be used to describe surfaces located on opposite sides of a fenestration unit frame. In actual use, an exterior surface of the fenestration unit frame could be found within the interior of a building or other structure where the surface would conventionally be defined as an interior surface, while an interior surface could be found outside of a building or other structure where the surface would conventionally be defined as an exterior surface.

Where used herein, the terms “above” and “below” are used in a relative sense to describe the location of features, etc. with respect to the direction of gravity when the fenestration units incorporating the fenestration unit frames described herein are properly installed in a building.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

The above summary is not intended to describe each embodiment or every implementation of the notch-welded fenestration frames with enhanced water and/or air performance and related methods as described herein. Rather, a more complete understanding of the invention will become apparent and appreciated by reference to the following Description of Illustrative Embodiments and claims in view of the accompanying figures of the drawing.

### BRIEF DESCRIPTION OF THE VIEWS OF THE DRAWING

Each of the figures described herein include axes corresponding to a three-dimensional Cartesian coordinate system to facilitate an understanding of the illustrative embodiments of the invention depicted in the figures and described herein.

FIG. 1 is front view of an interior side of fenestration unit in the form of single or double hung window incorporating one illustrative embodiment of a fenestration unit frame as described herein.

FIG. 2 is an enlarged view of a bottom portion of the fenestration unit frame of the fenestration unit depicted in FIG. 1 with the sill stop removed from the sill member.

FIG. 3 is an enlarged view of the sill stop removed from the fenestration unit frame as depicted in FIG. 2.

FIG. 4 is an enlarged view of the left side corner of the fenestration unit frame depicted in FIG. 2.

FIGS. 5-6 are isolated views of the side jamb of the corner of the fenestration unit frame depicted in FIG. 4 with graphic representations of material removed from the side jamb to form a notch of a side jamb as described herein.

FIGS. 7-8 depict the side jamb and sill member of FIG. 4 separated from each other.

FIG. 9 is an enlarged cross-sectional view of the sill member and sill stop of the illustrative embodiment of a fenestration unit frame as depicted in FIG. 1 with the sill stop disengaged from the sill member. This cross-section is taken in the Y-Z plane at a location proximate the middle of the sill member and sill stop in FIG. 1.

FIG. 10 is an enlarged cross-sectional view of the side jamb on the left side of the fenestration unit frame as depicted in FIG. 1 taken in the X-Z plane at a location above the sill member and sill stop.

FIG. 11 depicts one illustrative embodiment of the back or exterior face of the sill stop depicted in FIG. 3 with a flowable sealant applied thereto.

FIG. 12 includes enlarged views of the opposite ends of the sill stop depicted in FIG. 11.

FIG. 13 depicts one illustrative embodiment of positioning of a sill stop on a fenestration unit frame as described herein.

FIG. 14 depicts the sill stop depicted in FIG. 13 in position on the fenestration unit frame.

FIGS. 15A-15B are cross-sectional views depicting two alternative embodiments of two-piece sills that may be used in one or more embodiments of fenestration unit frames described herein.

FIG. 16 is an isometric view of one illustrative embodiment of one end of a sill member including exposed internal and external walls before assembly with and welding to a side jamb to form one corner of a fenestration unit frame as described herein.

FIG. 17 is an isometric view of one illustrative embodiment of one end of a side jamb including exposed internal and external walls before assembly with and welding to a sill member (e.g., the sill member depicted in FIG. 16) to form one corner of a fenestration unit frame as described herein.

FIGS. 18-19 depict the internal and external walls of the sill member of FIG. 16 and the side jamb of FIG. 17 that are welded together to form a corner of one illustrative embodiment of a fenestration unit frame as described herein, with the welded internal and external walls being shaded/cross-hatched in FIGS. 18-19.

FIG. 20 is an enlarged cross-sectional view taken in a Y-Z plane of one illustrative embodiment of a fenestration unit frame depicting a sash located above the sill (including a sill member and attached sill stop) along with primary and secondary containment tanks and associated water management features.

FIG. 21 is an isometric view of a corner of one illustrative embodiment of a fenestration unit frame as described herein, with the view being taken from above the sill on an exterior side of the fenestration unit frame.

FIG. 22 is an isometric view of the fenestration unit frame corner depicted in FIG. 21, with the view taken from below the sill on the exterior side of the fenestration unit frame.

### DESCRIPTION OF ILLUSTRATIVE EMBODIMENTS

In the following description of illustrative embodiments, reference is made to the accompanying figures of the drawing which form a part hereof, and in which are shown, by way of illustration, specific embodiments. It is to be understood that other embodiments may be utilized and structural changes may be made without departing from the scope of the present invention.

The fenestration unit frames described herein may be used in connection with any fenestration unit (e.g., window, door, etc.) including a frame constructed by welding at least the side jambs to the sill (where it is understood that the sill is the frame component installed at the bottom or lowermost portion of a properly installed fenestration unit). In one or more embodiments, the sill may include both a primary and secondary containment tank as described herein.

Although the illustrative embodiments described in connection with the figures depict a single/double hung window, the fenestration unit frames described herein may be used in connection with any suitable fenestration unit, e.g., sliding/gliding windows, casement windows, awning windows, etc. further, in one or more embodiments, the fenestration unit frames may also be adapted for use as a patio or entry door frame. As installed, the fenestration unit frames described herein include an exterior side and an interior side, where the exterior side typically (but not necessarily) faces the exterior of a building in which the fenestration units are installed and the interior side typically (but not necessarily) faces the interior of the building.

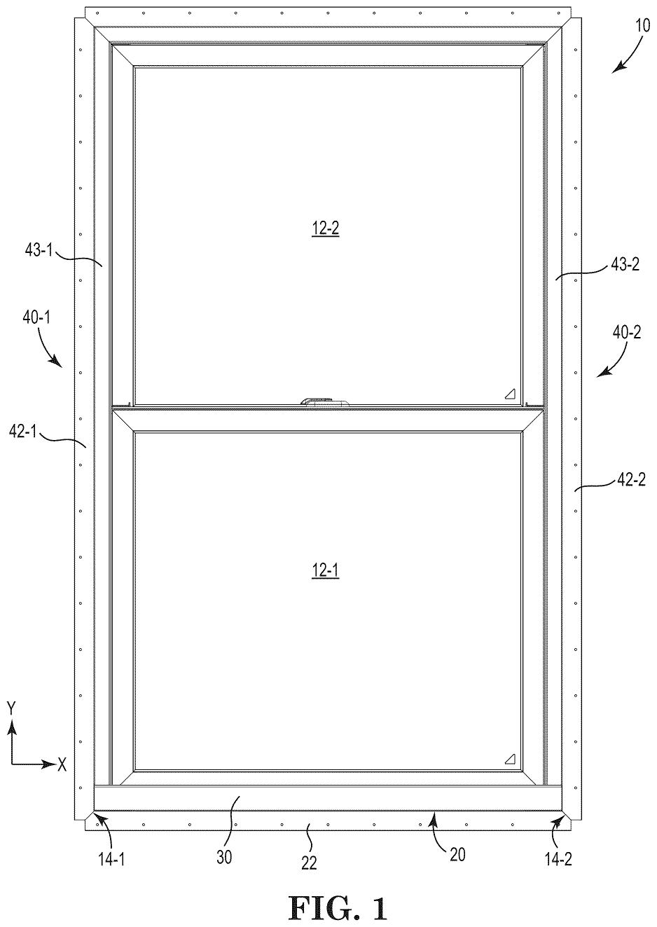

One illustrative embodiment of a single/double hung window 10 incorporating a fenestration unit frame as described herein is depicted in FIG. 1. The window 10 includes a pair of sashes 12-1 and 12-2 contained in the fenestration unit frame. The fenestration unit frame of window 10 includes a sill member 20 along with a first side jamb 40-1 and a second side jamb 40-2. The frame also includes a head jamb opposite the sill member 20. The first and second side jambs 40-1 and 40-2 are connected to each other by the sill member 20 and the head jamb. In the depicted illustrative embodiment, sill member 20 includes an optional nailing flange 22, side jamb 40-1 includes an optional nailing flange 42-1, and side jamb 40-2 includes an optional nailing flange 42-2.

The frame members of fenestration unit frames described herein, e.g., the sill members and side jambs, may be manufactured of material or materials capable of being thermally and/or chemically welded to form the corner junctions suitable for use in a fenestration unit frame. Nonlimiting examples of potentially suitable materials for the sill members and/or side jambs include any suitable weldable materials including, e.g., thermoplastics (e.g., polyvinyl chlorides (PVC), polypropylenes, nylons, acrylics, Acrylonitrile Butadiene Styrene (ABS), polycarbonates, etc. and composites thereof) and thermoplastic-based composites. When used, the thermoplastic and thermoplastic-based composites may be capped or uncapped with alternate weldable capstock materials (e.g., PVC, acrylics, etc.) that can be different from the primary substrate material. Examples of some potentially suitable weldable materials are marketed by Andersen Corporation under the tradename FIBREX (a fiber and PVC composite), variations of which may be described in, e.g., U.S. Pat. Nos. 5,585,155 (Heikkila et al.); 6,106,944 (Heikkila et al.); 6,210,792 Seethamraju et al.); 6,260,251 (Guhl); 6,280,667 (Koenig et al.); 6,342,172 (Finley); etc.

The specifics relating to welding temperatures, dwell times, etc. to be used when welding such materials may vary depending on a variety of factors including materials being welded, geometries, ambient temperature, etc. will be well known to one of skill in the art and will not be detailed herein.

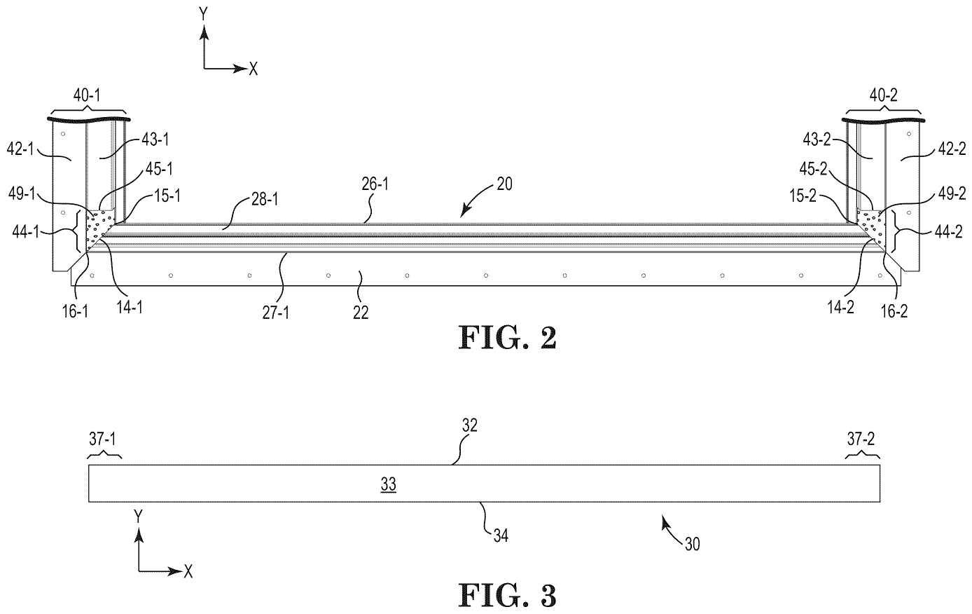

FIG. 2 is an enlarged view of a bottom portion of the fenestration unit frame of the fenestration unit 10 depicted in FIG. 1 with the sill stop 30 removed from the sill member 20 along the bottom of the frame and FIG. 3 is an enlarged view of the sill stop 30 removed from the fenestration unit frame as depicted in FIG. 2.

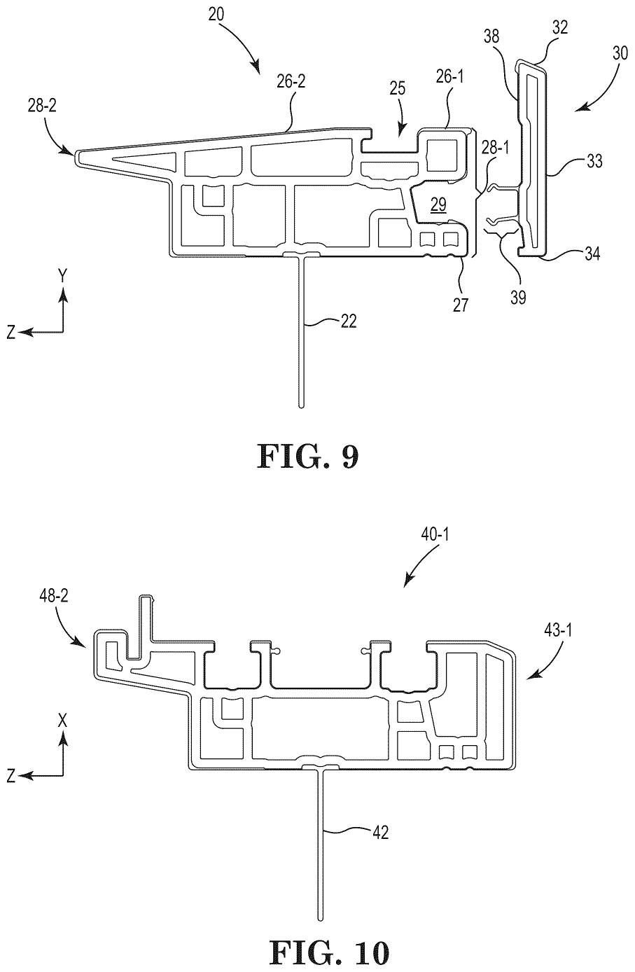

With reference to FIG. 2, the sill member 20 includes a first sill end proximate side jamb 40-1 and a second sill end proximate side jamb 40-2 at the opposite end of the sill member 20. The sill member 20 extends along a sill axis between the first sill end and the second sill end, the sill axis being aligned with the X axis of the Cartesian coordinate system depicted in FIG. 2. With the sill stop 30 removed from the sill member 20, the interior sill face 28-1 is exposed. Although typically covered by the sill stop 30, the interior sill face 28-1 can be described as being proximate an interior side of the fenestration unit frame. Although not depicted in FIG. 2, the sill member includes an exterior sill face on an exterior side of the fenestration unit frame (see, e.g., exterior sill face 28-2 in FIGS. 9, 15, 17, and 19-20). The interior sill face 28-1 and the exterior sill face are separated from each over a depth of the fenestration unit frame along an interior/exterior axis of the fenestration unit frame, with the interior/exterior axis aligned with the Z axis of the Cartesian coordinate system depicted in the figures.

The portion of the fenestration unit frame depicted in FIG. 2 also includes a bottom section of side jamb 40-1 on the left side of the sill member 20. The side jamb 40-1 is attached to the end of sill member 20 at a mitered frame joint 14-1. That mitered frame joint 14-1 is formed by welding at least portions of the sill member 20 to at least portions of the side jamb 40-1 as described herein. As a result, the mitered frame joint can be described as being a welded joint between the ends of the sill member 20 and side jamb 40-1. As discussed herein, while the welded portion of the joint is between mitered faces on the sill member 20 and the side jambs, other portions of the sill member and/or side jambs may not be mitered. In one or more embodiments, these non-mitered non-welded portions form the basis for the term “notch-welded” as used in connection with fenestration unit frames as described herein.

Side jamb 40-1 includes a side jamb interior face 43-1 on the interior side of the fenestration unit frame incorporating side jamb 40-1 and sill member 20. Side jamb 40-1 also includes a side jamb exterior face that is not visible in FIG. 2 because it is on the opposite side of the interior face 43-1 (see, e.g., side jamb exterior face 48-2 in FIGS. 10, 13-16, and 18-21). The side jamb interior face 43-1 and side jamb exterior face 48-2 are separated from each along the interior/exterior axis aligned with the Z axis of the Cartesian coordinate system depicted in the figures.

Similarly, the portion of the fenestration unit frame depicted in FIG. 2 also includes a bottom section of side jamb 40-2 on the right side of the sill member 20. The side jamb 40-2 is attached to the end of the sill member 20 at a mitered frame joint 14-2. That mitered frame joint 14-2 is formed by welding at least portions of the sill member 20 to at least portions of the side jamb 40-2 as described herein. As a result, the mitered frame joint can be described as being a welded joint between the ends of the sill member 20 and the side jamb 40-2.

Similar to side jamb 40-1, side jamb 40-2 also includes a side jamb interior face 43-2 on the interior side of the fenestration unit frame incorporating side jamb 40-2 and sill member 20. Side jamb 40-2 also includes a side jamb exterior face that is not visible in FIG. 2 because it is on the opposite side of the interior face 43-2 in a manner similar to side jamb exterior face 48-2 which is located on the opposite side of the interior face 43-1. The side jamb interior face 43-2 and side jamb exterior face of side jamb 40-2 are separated from each other along the interior/exterior axis aligned with the Z axis of the Cartesian coordinate system depicted in the figures.

One illustrative embodiment of a sill stop 30 that may be attached to the interior face 28-1 of the sill member 20 is depicted in FIG. 3. The sill stop 30 includes an upper edge 32, a lower edge 34, and a sill stop interior face 33 extending between the first side jamb 40-1 and the second side jamb 40-21 attached to the sill member 20. The upper edge 32 of the sill stop 30 is aligned with the sill axis (which, in the depicted embodiment is aligned with the X axis) and located above a top edge 26-1 of the interior sill face 28-2 between the first side jamb 40-1 and second side jamb 40-2 (the top edge 26-1 of interior sill face 28-2 is depicted in FIG. 2). The lower edge 34 of the sill stop 30 is located below the top edge 26-1 of the interior sill face 28-1 between the first side jamb 40-1 and the second side jamb 40-2 such that the sill stop 30 forms a dam above the sill member 20 between the first side jamb 40-1 and the second side jamb 40-2 (see also, FIG. 19).

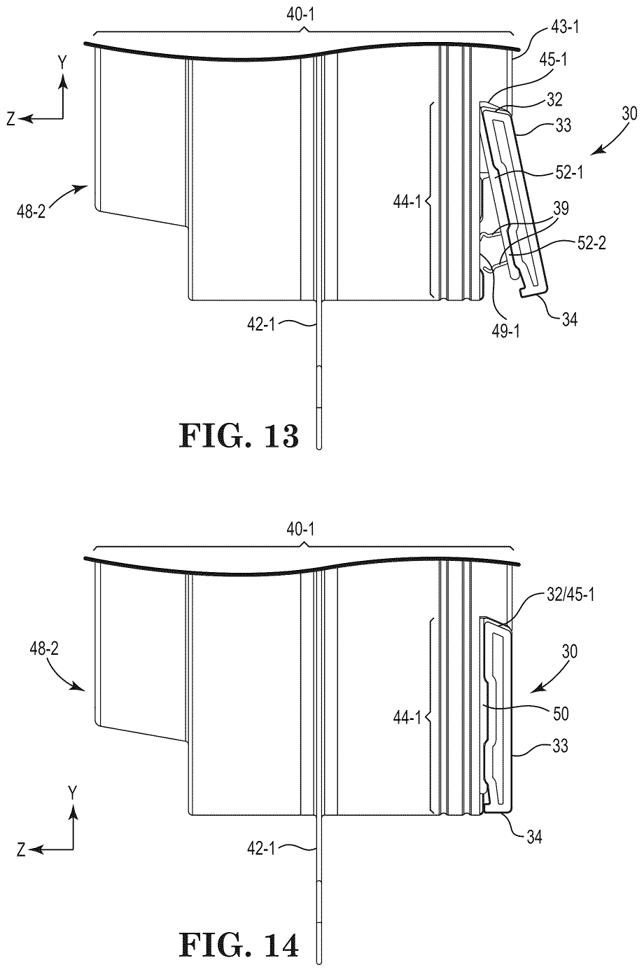

With reference to FIGS. 2 and 4-7, a first jamb notch 44-1 is formed into the side jamb interior face 43-1 of side jamb 40-1 proximate the end of the side jamb 40-1 at the mitered frame joint 14-1. The jamb notch 44-1 includes an exposed notch face 49-1 located between a first notch top edge 45-1 and the side jamb end 46-1. The exposed notch face 49-1 is inset from the side jamb interior face 43-1 (see, e.g., FIG. 13) and an end portion of the sill stop 30 occupies the jamb notch 44-1 such that the upper edge 32 of the sill stop 30 faces the top edge 45-1 of the jamb notch 44-1.

The depicted illustrative embodiment of the fenestration unit frame also includes a jamb notch 44-2 formed into the side jamb interior face 43-2 of side jamb 40-2 proximate the end of the side jamb 40-2 at the mitered frame joint 14-2. The jamb notch 44-2 includes an exposed notch face 49-2 located between the notch top edge 45-2 and the side jamb end forming the side jamb portion of the mitered frame joint 14-2. The exposed notch face 49-2 is also inset from the side jamb interior face 43-2 and an end portion of the sill stop 30 occupies the jamb notch 44-2 such that the upper edge 32 of the sill stop 30 faces the top edge 45-2 of jamb notch 44-2.

While the upper edge 32 of the sill stop 30 is described as facing the top edges 45-1/45-2 of jamb notches 44-1/44-2, it may be preferred the upper edge 32 of the sill stop 30 be aligned with the top edges 45-1/45-2 of jamb notches 44-1/44-2. In still other embodiments, it may be preferred that no significant gap be provided between the upper edge 32 of the sill stop 30 and the top edges 45-1/45-2 of the jamb notches 44-1/44-2 to, for example, improve the aesthetics of the fenestration unit frames described herein.

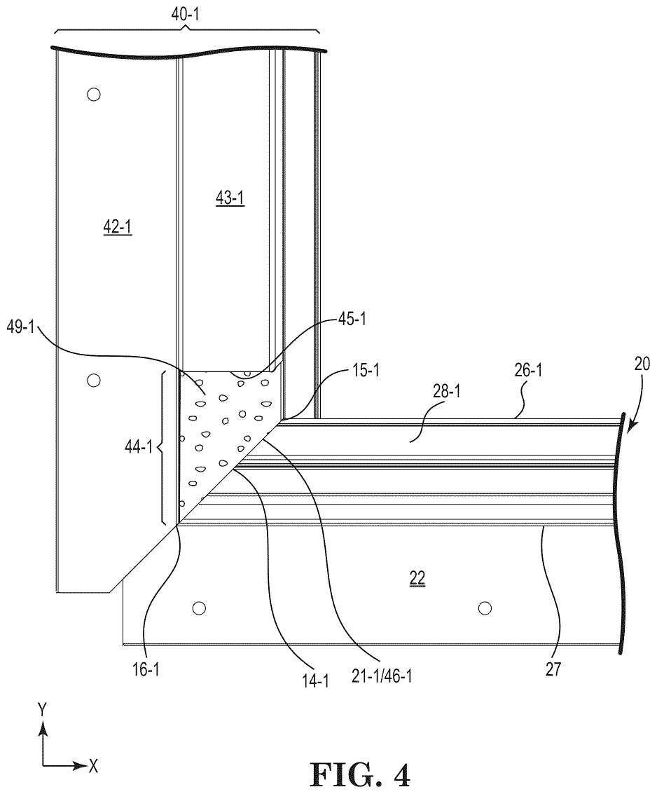

With reference to FIG. 4, the enlarged view of the left side corner of the fenestration unit frame provides a clearer view of various features of the mitered frame joint 14-1 including, for example, that the mitered frame joint 14-1 extends from an inside corner 15-1 to an outside corner 16-1. The inside corner 15-1 is located within the interior of the fenestration unit frame while the outside corner 16-1 is located at the opposite end of the mitered frame joint 14-1, which may be referred to as an outside corner joint between the sill member and the side jamb of the fenestration unit frame.

With reference to, e.g., FIGS. 1-4, the depicted illustrative embodiment of sill stop 30 includes end portions 37-1 and 37-2 that occupy the jamb notches 44-1 and 44-2 such that the upper edges 32 of the sill stops 30 are aligned with the top edges 45-1 and 45-2 of the jamb notches 44-1 and 44-2 on side jambs 40-1 and 40-2. In one or more embodiments of the fenestration unit frames described herein, the end portions 37-1 and 37-2 of the sill stops 30 may be described as covering at least a portion of the interior edges of the mitered frame joints 14-1 and 14-2 at opposite ends of the sill members 20.

In the depicted illustrative embodiment, the end portions 37-1 and 37-2 of the sill stop 30 cover the interior edges of the mitered frame joints 14-1 and 14-2 from their respective inside corners 15-1 and 15-2 to their respective outside corners 16-1 and 16-2 when the sill stop 30 is in position on the sill member 20 as described herein.

In the depicted illustrative embodiment of the fenestration unit frame as depicted in, e.g., FIGS. 1-4, the end portions 37-1 and 37-2 of the sill stop 30 can also be described as covering the exposed notch faces 49-1 and 49-2 of the side jambs 40-1 and 40-2 between the top edges 45-1 and 45-2 of the jamb notches 44-1 and 44-2 and the interior edges of the mitered frame joints 14-1 and 14-2.

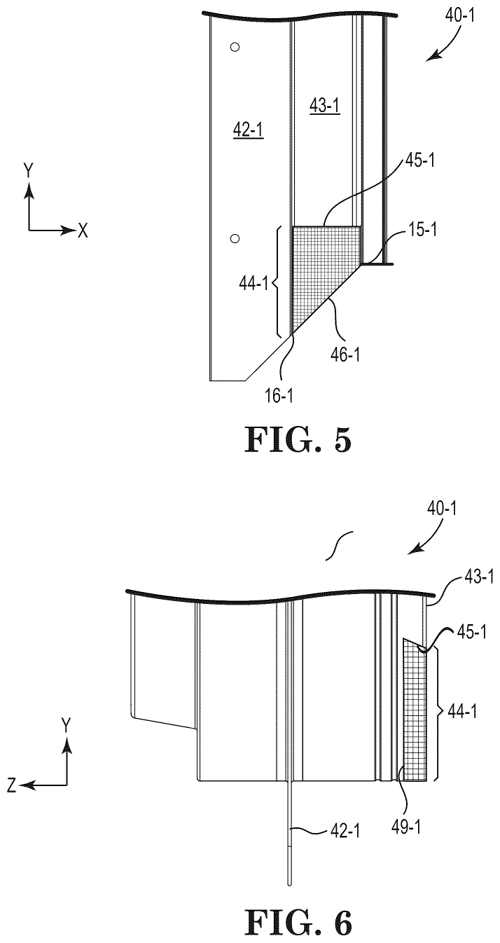

With reference to FIGS. 5-6, the shaded/cross-hatched areas are provided to illustrate removal of a portion of the side jamb 40-1 to form the notch at the end 46-1 of side jamb 40-1. In particular, the shaded/cross-hatched portion as seen in FIGS. 5 and 6 is the portion of the side jamb 40-1 removed to form the notch 44-1 in side jamb 40-1. Manufacturing of the fenestration unit frames as described herein involves forming angled or mitered end portions that mate with similarly angled or mitered end portions of the sill member as seen in, e.g., FIG. 4. After those mitered end portions have been formed, one or more embodiments of methods of forming notches in side jambs as described herein typically involves removing some of the material forming the interior face 43-1 of the side jamb 40-1 by, e.g., routing, coping, machining, sawing, grinding, etc.

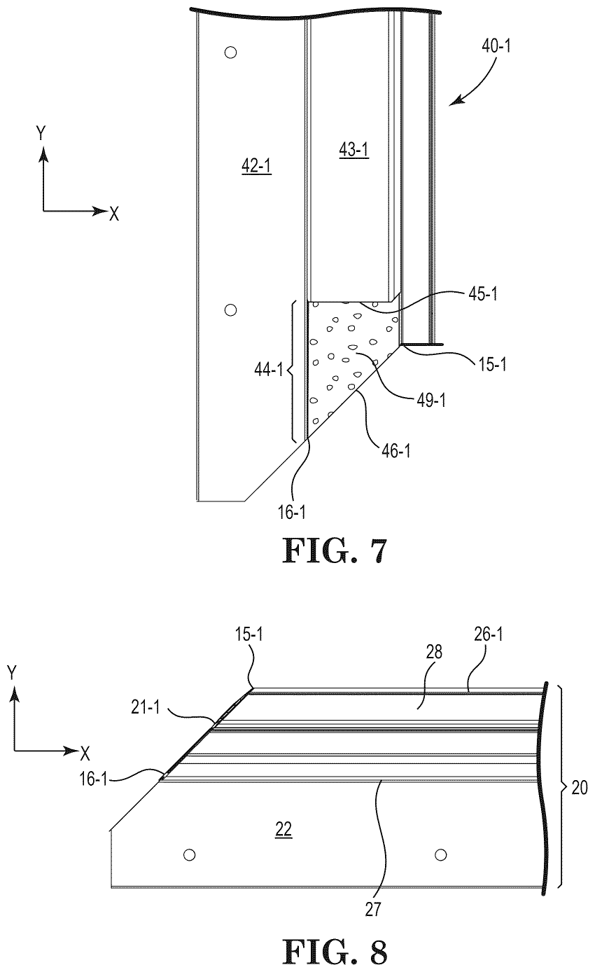

With reference to FIG. 7, removal of a portion of the side jamb 40-1 to form the notch 44-1 forms an exposed notch face 49-1 located between the notch top edge 45-1 and the end 46-1 of the side jamb 40-1. The ends of the exposed notch face 49-1 at the end 46-1 of side jamb 40-1 can be found at both the inside corner 15-1 and outside corner 16-1 of the corner formed by the side jamb 40-1 and sill member 20.

With reference to FIG. 8, the complementary mitered end 21-1 on sill member 20 is shaped to mate with the mitered end 46-1 of side jamb 40-1 and, when welded together, the ends 46-1 and 21-1 form a mitered frame joint 14-1 as seen in, e.g., FIG. 2. The end 21-1 of sill number 20 also terminates at the inside corner 15-1 and outside corner 16-1 of the corner formed by the sill member 20 with side jamb 40-1 when assembled as seen in, e.g., FIG. 4.

As discussed herein the sill stop 30 is positioned on the interior sill face of the sill member 20 in FIG. 1 while the sill stop 30 is removed from the interior sill face 28-1 of the sill member in FIG. 2. FIG. 9 depicts placement of the depicted illustrative embodiment of sill stop 30 on sill member 20. The enlarged cross-sectional view of the sill member 20 and sill stop 30 as depicted in FIG. 1 is taken in the Y-Z plane at a location proximate the middle of the sill member 20 and sill stop 30 between the side jambs 40-1 and 40-2 in FIG. 1.

As depicted in FIG. 9, sill member 20 includes interior sill face 28-1 facing the exterior face 38 of sill stop 30. The interior sill face 28-1 extends from the top edge 26-1 to the bottom edge 27 of sill member 20. Sill member 20 further includes an upper exterior surface 26-2, with the upper exterior surface 26-2 of sill member 20 being separated from top edge 26-1 by an optional trough 25 which, in use, may preferably sit beneath a sash or other panel in a fenestration unit in which the sill member 20 forms a part of a fenestration unit frame. FIG. 9 also depicts the exterior sill face 28-2 as well as the optional nailing flange 22 on the sill member 20.

The sill stop 30 depicted in FIG. 9 includes an upper edge 32 and lower edge 34 along with, as noted above, an exterior face 38 that faces the interior sill face 28-1 of sill member 20. Also depicted in this illustrative embodiment of sill stop 30 are stop retention/alignment features 39 that are configured to be inserted into a cavity 29 formed in the interior sill face 28-1 of sill member 20 to ensure proper alignment of the sill stop 30 as well as provide some retention force to retain sill stop 30 in position on the interior sill face 28-1 of sill member 20.

In the depicted illustrative embodiment, the lower edge 34 of sill stop 30 may preferably be flush with the bottom edge 27 of the sill member 20 to provide a finished appearance to the sill portion of a fenestration unit frame and ensure ease of applying interior trim and/or other aesthetic finishing materials as part of the installation and finishing process.

FIG. 10 is an enlarged cross-sectional view of the side jamb 40-1 on the left side of the fenestration unit frame as depicted in FIG. 1. The cross-sectional view is taken in the X-Z plane at a location above the sill member 20 and sill stop 30. The side jamb 40-1 includes a jamb interior face 43-1 and a jamb exterior face 48-2. In one or more embodiments, the jamb exterior face 48-2 may preferably (but not necessarily) align with the sill exterior face 28-2 of sill member 20 in a fenestration unit frame such that the exterior faces are coplanar about the exterior side of the fenestration unit frame. By “coplanar” as used herein, it is meant that the faces lie in the same general plan, i.e., perfect coplanarity is not required and may be difficult to achieve in view of manufacturing tolerances and other factors.

In one or more embodiments of the fenestration unit frames described herein, the interior/exterior side jamb depth (measured along the Z axis in the depicted Cartesian coordinates) between the jamb interior face 43-1 and jamb exterior face 48-2 is preferably (but not necessarily) equivalent to the interior/exterior sill depth of the assembled sill member 20 and sill stop 30 (where the sill depth is measured between the sill stop interior face 33 and the exterior sill face 28-2). In embodiments in which the side jamb depth is equivalent to the sill depth, the interior faces of the side jambs and the sill stops may be coplanar on the interior side of the fenestration unit frame.

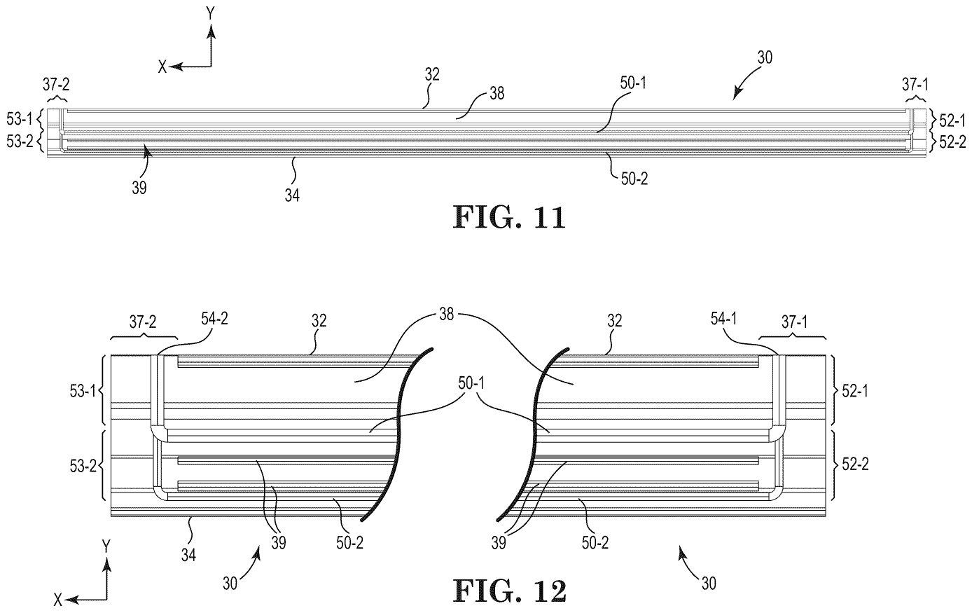

With reference to FIGS. 11-14, one or more embodiments of the fenestration unit frames described herein may include a seal located between the sill stop and the interior sill face to provide a barrier to water penetration and air infiltration to the interior side of the fenestration unit frame. FIGS. 11-12 depict the exterior face 38 of illustrative embodiment of sill stop 30 which includes, for example, optional retention features 39 as described above in connection with FIG. 9.

Also included in the depicted illustrative embodiment of sill stop 30 is a primary seal 50-1 that extends along the width of the sill stop 30 between the end portions 37-1 and 37-2. Primary seal 50-1 includes an end section 52-1 in end portion 37-1 at one end of the sill stop 30 and an end section 53-1 in the end portion 37-2 at the opposite end of the sill stop 30. When properly placed on a sill member such as, e.g., sill member 20 as described herein, the end sections 52-1 and 53-1 of the seal 50-1 are located between the end portions 37-1 and 37-2 of the sill stop 30 and the exposed notch faces 49-1 and 49-2 of the notches 44-1 and 44-2. For example, FIG. 1 depicts such an arrangement when sill stop 30 is in position on the sill member 20 of the fenestration unit frame.

With reference to FIGS. 2-3 as well as FIGS. 11-12, it can be seen that the end sections 52-1 and 53-1 of the seal 50-1 extend across the interior edges of the mitered frame joints 14-1 and 14-2 at opposite ends of the sill member 20.

In addition, the end sections 52-1 and 53-1 of the seal 50-1 are located proximate the upper edge 32 of the sill stop 30. Further, the upper edge 32 of sill stop 30 is located above the top edge 26-1 of sill member 20 as seen in, e.g., FIG. 9. As a result, the end sections 52-1 and 53-1 of seal 50-1 may be described as being located above the top edge 26-1 of the interior sill face 28-1 of sill member 20 in the exposed notch faces 49-1 and 49-2 of notches 44-1 and 44-2 on side jambs 40-1 and 40-2.

In one or more embodiments, the end sections 52-1 and 53-1 of the seal 50-1 may each include a terminal seal end 54-1 and 54-2 located closer to the upper edge 32 of the sill stop 30 than the lower edge 34. Positioning the terminal seal ends 54-1 and 54-2 close to or at the upper edge 32 of the sill stop 30 may, in one or more embodiments, result in a seal that extends continuously from the top edge 45-1 of jamb notch 44-1 of side jamb 40-1 across the sill stop 30 and sill member 20 to the top edge 45-2 of jamb notch 44-2 of side jamb 40-2 to provide an effective barrier to water penetration and air infiltration through the interfaces between the sill member 20 and side jambs 40-1/40-2 and/or sill stop 30.

The positions of the terminal seal ends 54-1 and 54-2 of the seal 50-1 may, in one or more embodiments, define the water column height that the sill of the fenestration unit frame can contain without leakage to the interior side of the fenestration unit frames as described herein. In other words, it may be advantageous to extend the seal such that the terminal ends 54-1 and 54-2 are proximate the upper edge 32 of sill stop 30 such that the effective water column height that can be contained by sill stop 30 is roughly equal to the height of the sill stop 30.

In addition to seal 50-1 with its end sections 52-1 and 53-1, the depicted illustrative embodiment of sill stop 30 also includes an optional second seal 50-2 located closer to the lower edge 34 of the sill stop 30. Seal 50-2 also includes end sections 52-2 and 53-2 located in, respectively, end portions 37-1 and 37-2 of sill stop 30. In the depicted illustrative embodiment, the terminal ends of seal 50-2 merge with the end sections 52-1 and 53-1 of seal 50-1. Seal 50-2 may provide redundancy in the seal structure on the sill stop 30 to improve robustness of the water control system provided by sill member 20 and sill stop 30 along with side jambs 40-1 and 40-2. In one or more embodiments, the optional second seal 50-2 may also increase the long-term retention strength and durability of the connection of the sill stop 30 to the sill member 20 as well as the resistance to water penetration and air infiltration. If only strength is needed, not redundant water and air performance, then it is not critical that the terminal ends of the end sections 52-2 and 53-2 of seal 50-2 merge with and be continuous with the end sections 52-1 and 53-1 of seal 50-1.

With reference to FIGS. 13-14, assembly of the sill stop 30 (with the seals 50-1 and 50-2) on the side jamb 40-1 and sill member 20 is depicted. As seen in FIG. 13, the sill stop 30 may be positioned such that the upper edge 32 abuts top edge 45-1 of notch 44-1 in the side jamb 40-1. End sections 52-1 and 52-2 of seals 50-1 and 50-2 contact the exposed notch faces 49-1 of side jamb 40-1 as the sill stop 30 is moved into position in the notch as seen in FIG. 14.

With the sill stop 30 in position as seen in FIG. 14, seal 50 extends along the edge of the sill stop 30 to a position proximate the upper edge 32 of sill stop 30 and top edge 45-1 of notch 44-1. As a result, water column height that can be contained by the sill stop 30 extends essentially to the upper edge 32 of sill stop 30. Furthermore, sealant 50 is not exposed along the interior face 43-1 of the side jamb 40-1 to provide a clean and aesthetically pleasing appearance to the finished fenestration unit frame.

Another feature depicted in FIG. 14 is the coplanar positioning of the interior face 33 of the sill stop 30 with the interior face 43-1 of the side jamb 40 when the sill stop 30 is in position as depicted in FIG. 14.

In one or more embodiments, the seals provided between the sill stops and sill members as described herein may be provided in any suitable form. For example, in one or more embodiments, the seals may be provided in the form of one or more gaskets (constructed of foam, rubber, butyl, or similar elastomeric materials, etc.) on one or more of the sill stop 30, interior faces of the side jambs, and interior face of the sill member 20 to provide a suitable barrier to water penetration and air infiltration between the sill stop 30 and the interior face 28-1 of sill member 20 as well as the interior faces of the side jambs as discussed herein.

In one or more alternative embodiments, the seals may be provided in the form of a flowable material (e.g., sealants, adhesives, cements, etc.) deposited on one or more of the sill stop, the interior face of the sill member, the exposed notch faces of the side jambs, etc. Seals provided as a flowable material may, in one or more embodiments, also assist in or provide for the primary mode of attaching and/or retaining the sill stops on the fenestration unit frames as described herein. In one or more embodiments, the retention/alignment features 29/39 on the sill member 20 and sill stop 30 may be provided only align and/or retain the sill stops in position on the fenestration unit frame while the flowable material of the seal cures, hardens, dries, etc. while in one or more alternative embodiments, no retention/alignment features are provided.

Examples of some potentially suitable flowable materials may include, but are not limited to: methyl methacrylate sealants/adhesives, 1 component urethane sealants/adhesives, 2 component urethane sealants/adhesives, 2 component epoxy-based sealants/adhesives, hotmelt sealants/adhesives, 1-& 2-part acrylic sealants, hybrid polymer sealants/adhesives (e.g., SPUR and MS Polymer), 1 component silicone sealants/adhesives (including, e.g., structural silicone adhesives), 2 component silicone sealants/adhesives (including, e.g., structural silicone adhesives), solvent based sealants/adhesives, water based sealant/adhesives, etc. Regardless of the specific material or materials used as flowable material to provide the seals described herein, the flowable materials/methods selected would only need to be appropriate for the materials used to construct the fenestration unit frames and sill stops as described herein.

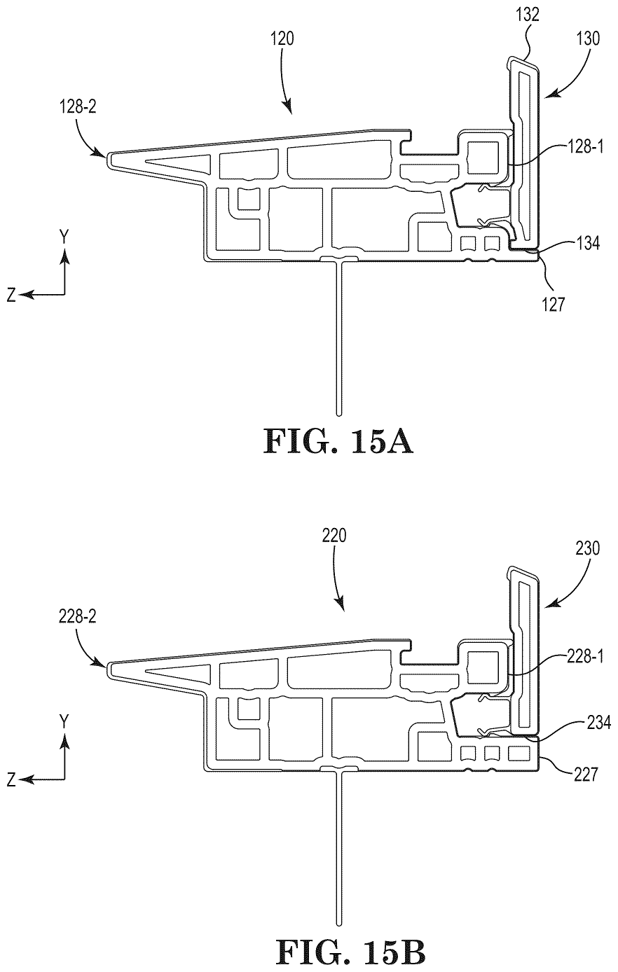

In one or more embodiments, the sill stops and sill members of the fenestration unit frames described herein may be constructed such that the sill stop essentially hides or obscures the sill members when the sill stops are in position on the sill members, see, for example, sill stop 30 as depicted in FIG. 14 in which the lower edge 34 of the sill stop 30 extends to the bottom edge 27 of the sill member 20. FIGS. 15A and 15B depict two potential alternative embodiments in which the lower edges of the sill stops do not extend to the bottom edges of the sill members.

In FIG. 15A, the sill member 120 includes an interior sill face 128-1 and exterior sill face 128-2 along with a bottom edge 127 along the bottom of the sill member 120. The sill stop 130 includes an upper edge 132 and a lower edge 134. In this depicted embodiment, the lower edge 134 of the sill stop 130 rests on the bottom edge 127 of the sill member 120. Such an arrangement may provide a convenient reference for proper placement of the sill stop 130 on the sill member.

FIG. 15B depicts another alternative embodiment in which the bottom edge 227 of the sill member 220 provides more robust support for the lower edge 234 of the sill stop 230. Sill member 220 includes an interior sill face 228-1 and an exterior sill face 228-2 along with bottom edge 227.

As discussed herein, one or more embodiments of the fenestration unit frames described herein may include water management features to facilitate capture and drainage of water incident on the exterior side of a fenestration unit incorporating a fenestration unit frame as described herein. In one or more embodiments, the sill members and side jambs, although having dissimilar profile, include strategically designed shared/corresponding internal and external walls that, when selectively welded to each other provide both strength at the corners of the fenestration unit frames while defining both primary and, optionally, secondary containment tanks in sill members to enhance water containment and drainage.

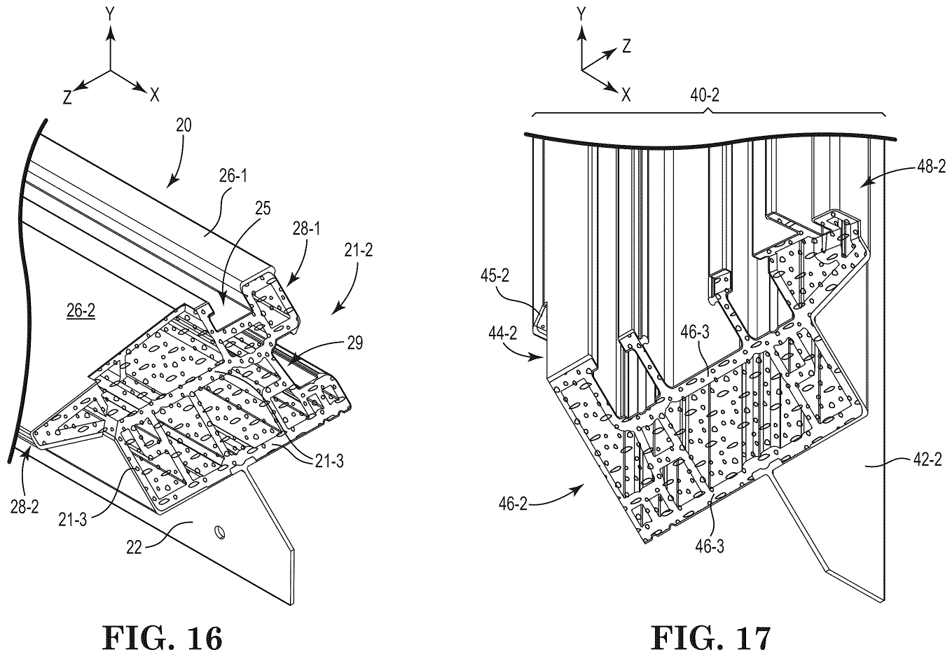

The sill members and side jambs depicted in FIGS. 16-22 are one illustrative embodiment of this design strategy and it should be understood that the depicted internal and external walls provide only one approach to providing a fenestration unit frame that provides strong welded corners with primary and secondary containment tanks in a sill member.

With reference to FIG. 16, a sill end 21-2 of sill member 20 is depicted. Sill end 21-2 is used to form the mitered frame joint 14-2 at the bottom right corner of the fenestration unit frame depicted in connection with the fenestration unit 10 of FIG. 1. The depicted sill member 20 includes top edge 26-1, trough 25, upper exterior surface 26-2, interior sill face 28-1, exterior sill face 28-2, nailing flange 22, and cavity 29, all of which are described elsewhere herein.

Sill end 21-2 provides a sill face consisting of exposed edges 21-3 (only some of which are indicated by reference numbers 21-3) corresponding to the internal and external walls of sill member 20. The exposed edges 21-3 of sill end 21-2 are typically formed by removing a portion of the sill member 20 to form a mitered end 21-2 for welding to the side jambs as described herein. The exposed edges 21-3 may, for example, be formed by any suitable process including, but not limited to, milling, routing, cutting, sanding, machining, sawing, grinding, etc.

FIG. 17 depicts a complementary side jamb end 46-2 of side jamb 40-2. Side jamb end 46-2 is used to form the mitered frame joint 14-2 at the bottom right corner of the fenestration unit frame depicted in connection with the fenestration unit 10 of FIG. 1. The depicted side jamb 40-2 includes a notch 44-2 having a top edge 45-2 with the notch 44-2 and top edge 45-2 being formed in the interior face of side jamb 40-2 as described herein (noting that the interior face of side jamb 46-2 is not visible in the isometric view of FIG. 17). Side jamb 40-2 also includes an exterior face 48-2 and nailing flange 42-2 as described elsewhere herein.

Side jamb end 46-2 provides side jamb faces consisting of exposed edges 46-3 (only some of which are indicated by reference numbers 46-3) corresponding to the internal and external walls of side jamb 40-2. The exposed edges 46-3 of side jamb end 46-2 are also typically formed by removing a portion of the side jamb 40-2 to form a mitered end 46-2 for welding to the sill end 21-2 of FIG. 16. The exposed edges 46-3 may, for example, be formed by any suitable process including, but not limited to milling, routing, cutting, sanding, grinding, machining, sawing, etc.

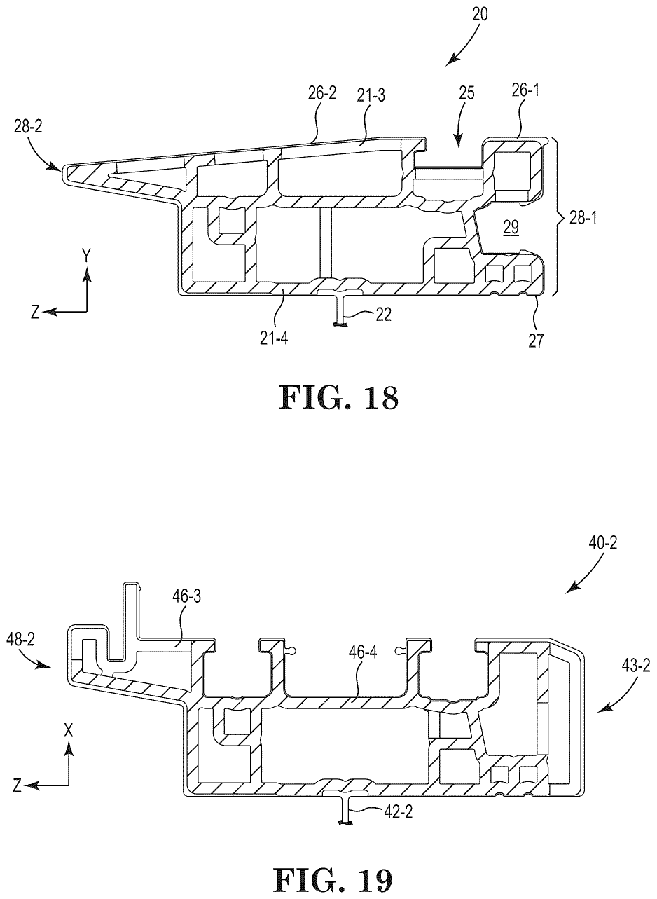

FIGS. 18-19 are provided to depict the internal and external walls of the sill member 20 and side jamb 40-2 that are welded together to form the bottom right side corner of a fenestration unit frame as described herein. FIG. 18-19 are end views of their respective components, with FIG. 18 being a view of sill member 20 along the X axis of the Cartesian coordinates provided in the figures and FIG. 19 being a view of side jamb 40-2 along the Y-axis of those Cartesian coordinates.

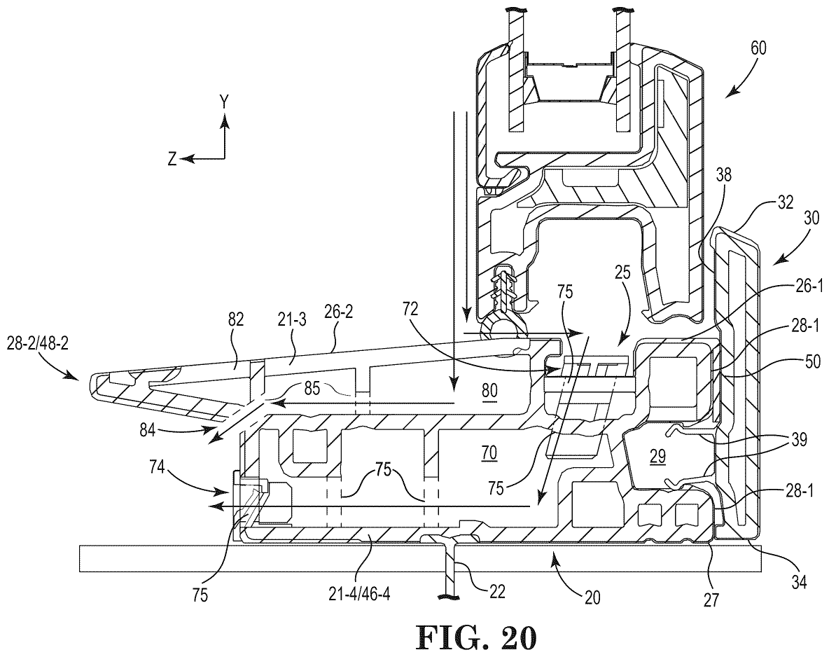

The end view of sill member 20 in FIG. 18 includes the exposed edges 21-3 formed in sill end 21-2 as seen in FIG. 16. Similarly, the end view of side jamb 40-2 in FIG. 19 includes the exposed edges 41-3 formed in the side jamb end 46-2 as seen in FIG. 17. The shaded/cross-hatched portions 21-4 of the exposed edges 21-3 of sill member 20 and the shaded/cross-hatched portions 46-4 of exposed edges 46-3 of side jamb 40-2 indicate the selected portions of the exposed edges 21-3 on sill member 20 and the selected portions of exposed edges 46-3 on side jamb 40-2 that are welded to each other in the mitered frame joint 14-2 at the bottom right side corner of the fenestration unit frame depicted in FIG. 1. The shaded/cross-hatched portions 21-4 on sill member 20 and shaded/cross-hatched portions 46-4 on side jamb 40-2 define some of the water management features that are discussed herein including below in connection with FIG. 20.

FIG. 20 is an enlarged cross-sectional view taken in the Y-Z plane (i.e., along the X-axis of the Cartesian coordinates) of the sill member 20. FIG. 20 includes both the sill stop 30 attached to sill member 20 as well as the bottom portion of a sash 60 positioned above the sill member 20 and can be used to discuss one illustrative embodiment of a sill member including primary and secondary containment tanks and associated water management features as described herein.

Among the features of sill member 20 depicted in FIG. 20 are the top edge 26-1, upper exterior surface 26-2, bottom edge 27, interior sill face 28-1, exterior sill face 28-2, nailing flange 22, cavity 29, and trough 25, all of which are described in connection with various figures herein. Also depicted in FIG. 20 are features of sill stop 30 including upper edge 32, lower edge 34, exterior face 38, and optional retention/alignment features 39.

FIG. 20 provides a clear illustration of the relationship between the sill stop 30 and sill member 20 along with a collection of the features that provide for improved water management in the fenestration unit frames as described herein. In particular it can be seen in FIG. 20 that the upper edge 32 of sill stop 30 is located above the top edge 26-1 of the sill member 20 between the side jambs at opposite ends of the sill member 20 such that the sill stop 30 forms a dam above the sill member 20 between the side jambs.

One advantage of providing a separate sill stop 30 that is attached to the sill member 20 is that the height of the upper edge 32 of sill stop 30 above top edge 26-1 of sill member 20 can be selected to provide a desired water column height for the sill of a fenestration unit frame as described herein. As discussed herein, the notches provided in the side jambs to accept the end portions of the sill stop can also be modified to accept a taller or shorter sill stop as desired.

In addition to the dam formed by sill stop 30 on sill member 20, FIG. 19 also depicts the water management features that facilitate capture and drainage of water incident on the exterior side of a fenestration unit incorporating a fenestration unit frame as described herein.

In particular, FIG. 20 overlays the shaded/cross-hatched portions 21-4 and 46-4 of exposed edges 21-3 and 46-3 to illustrate both the primary and secondary containment tanks formed within sill member 20 by welding of selected shared internal and external walls in the sill members and side jambs at the mitered frame corners of a fenestration unit frame as described herein.

The formation of containment tanks in sills of fenestration units along with associated entry and exit openings into and out of those containment tanks are discussed in known “contain and drain” sill systems such as those described in, e.g., U.S. Pat. No. 9,863,183 (Johnson et al.) and US Patent Publication No. 2024/0254819 (Rietz et al.).

As implemented in the illustrative embodiment of the fenestration unit frame described herein, FIG. 20 depicts a set of openings 75 formed in various the interior and exterior walls of the sill member 20. The openings 75 can be formed through milling, routing, drilling, etc. at any suitable point during the manufacturing process as described in, e.g., the patent documents identified above.

The openings 75 include openings proximate the bottom of the trough 25 to receive a trough drain 72 configured to drain water collected in the trough 25 to the primary containment tank 70. The depicted trough drain 72 is only one illustrative embodiment of a potentially suitable trough drain 72. In one or more embodiments, the trough drain 72 could be a simple as an aperture formed through the wall at the bottom of the trough 25.

Primary containment tank 70 includes additional openings 75 in the internal walls of sill member 20 to allow for passage of water entering primary containment tank 70 out of the sill member through, e.g., a primary exterior drain that is configured to drain water in the primary containment tank 70 to the exterior side of the fenestration unit frame in which sill member 20 is located. In the depicted embodiment, the primary exterior drain is in the form of a weep drain cover 74 positioned in opening 75 proximate the exterior side of the fenestration unit frame.

Although only one set of openings 75 is depicted in FIG. 20, it should be understood that a series of such openings may be provided along the length of the sill member 20 in sufficient numbers and sizes to accommodate enough trough drains 72 and weep drain cover 74 and associated openings 75 to allow for proper drainage of water collected in trough 25 to the exterior side 28-2 of sill member 20.

While such primary containment tanks along with their related features are known, the sill members of the fenestration unit frames described herein may also include secondary containment tanks. The secondary tanks are provided to drain water entering the sill members through junctions between the upper exterior surfaces of the sill members and the side jambs at the fenestration unit frame corners in which welding or otherwise sealing the upper exterior surfaces of the sill members fully to the side jambs is not possible to accommodate all of the functional requirements of the fenestration unit frame.

With reference to FIG. 20, the sill member 20 includes a secondary containment tank 80 located below the upper exterior surface 26-2 of sill member 20 and above the primary containment tank 70. The secondary containment tank 80 is also located between the trough 25 and the exterior sill face 28-2. Secondary containment tank 80 is drained at least in part by openings 85 in one or more interior walls located within secondary containment tank 80.

Secondary containment tank 80 also includes a secondary exterior drain 84 in sill member 20, the secondary exterior drain 84 being configured to drain water in the secondary containment tank 80 to the exterior side of the fenestration unit frame incorporating the sill member 20. Although the depicted embodiment of the secondary exterior drain 84 of secondary containment tank 80 does not include an insert such as a weep drain insert 74 described herein in connection with the primary containment tank 70, one or more alternative embodiments may include a cover configured to prevent the entry of air, debris etc. and/or provide aesthetic enhancement of or other functionality to the secondary containment tank 80 while still functioning to drain the secondary containment tank 80.

Although only one set of openings 85 of the secondary containment tank 80 is depicted in FIG. 20, it should be understood that any selected number of openings 85 may be provided along the length of the sill member 20 in sufficient numbers and sizes to accommodate drainage of water collected in the secondary containment tank 80 to the exterior side 28-2 of the sill member 20.

In one or more embodiments, the primary containment tank 70 and secondary containment tank 80 may be fluidically isolated from each other within the sill member 20. Isolating the primary and secondary containment tanks 70 and 80 from each other may protect the primary containment tank 70 from being overrun with water delivered into the secondary containment tank 80.

Although the secondary containment tank 80 is located above the primary containment tank 70 in the depicted illustrative embodiment of sill member 20, it should be understood that in one or more alternative embodiments such an arrangement between the secondary containment tank 80 and the primary containment tank 70 may not be required.

Also, although the secondary exterior drain 84 is, in the depicted illustrative embodiment, located above the primary exterior drain containing weep drain cover 74, it should be understood that in one or more alternative embodiments, such an arrangement between the secondary exterior drain and the primary exterior drain may not be required.

Sill members of fenestration unit frames described herein do not necessarily include openings on their upper exterior surfaces that would allow entry of water into the interior volume of the sill members. It can, however, be difficult or impossible to weld sill members to side jambs at the exterior sill-side jamb junctions found at the ends of the upper exterior surfaces of the sill members to provide water-tight junctions that are also aesthetically acceptable. As a result, water can enter the secondary containment tanks through those exterior sill-side jamb junctions in a welded frame constructions as described herein.

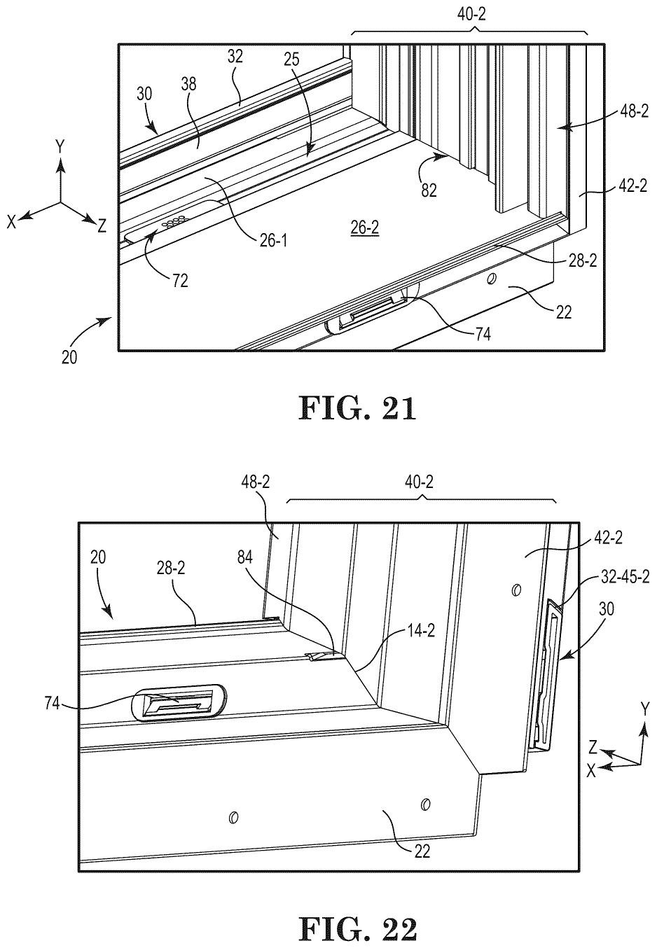

With reference to FIGS. 20-22, those exterior sill-side jamb junctions 82 are found at the junction between the upper exterior surface 26-2 of sill member 20 and the side jambs such as, e.g., side jamb 40-2 depicted in FIG. 21. The unsealed nature of that junction is at least partially depicted in FIG. 20 where the exterior sill-side jamb junction 82 is depicted as being a part of the sill member 20 that is not welded to the side jamb at the end of the sill member 20.

Water passing through the exterior sill-side jamb junction 82 at each end of the sill member 20 enters the secondary containment tank 80 where it collects before being drained to the exterior side of the fenestration unit frames through secondary exterior drain 84 in the depicted embodiment. In those embodiments in which the secondary containment tank 80 is fluidically isolated from the primary containment tank 70, water collected in the secondary containment tank 80 (and/or air in that same tank 80) never enters the primary containment tank 70 or any other interior portion of the sill member 20.

The isometric view of FIG. 21 depicts a bottom right corner of the fenestration unit frame of the illustrative embodiment of a fenestration unit as depicted in, e.g., FIG. 1. In particular, the isometric view of FIG. 21 is taken from above the sill member 20 on an exterior side of the fenestration unit frame. Among the features depicted in FIG. 21 are sill member 20, sill stop 30, and side jamb 40-2.

Sill member 20 includes upper exterior surface 26-2 which, as discussed herein, forms a junction 82 with the side jamb 40-2. Sill member 20 as depicted in FIG. 21 also includes trough 25 and top edge 26-1, as well as nailing flange 22. Upper exterior surface 26-2 extends outwardly from the trough 25 to the exterior sill surface 28-2.

Also depicted in FIG. 21 is a trough drain 72 positioned in trough 25 to, as discussed herein, drain water from the trough 25 into a primary containment tank located within sill member 20. In addition to trough drain 72, the sill member 20 depicted in FIG. 21 also includes a primary tank drain with a weep drain cover 74 located therein. The primary tank drain 74 is configured to drain water in the primary containment tank of sill member 20 to the exterior side of the fenestration unit frame as described herein.

Sill stop 30 includes, as depicted in FIG. 21, an upper edge 32 located above the top edge 26-1 of sill member 20 along with an exterior surface 38 facing the sill member 20 to form a dam as discussed herein.

Side jamb 40-2 includes, as depicted in FIG. 21, an exterior side jamb face 48-2 as well as a nailing flange 42-2.

FIG. 22 is an isometric view of the fenestration unit frame corner depicted in FIG. 21, with the view taken from below the sill member 20 on the exterior side of the fenestration unit frame. Among the features depicted in FIG. 22 are sill member 20 and side jamb 40 which meet at mitered frame joint 14-2. Among the features of sill member 20 depicted in FIG. 22 are the exterior sill surface 28-2 and nailing flange 22. In addition, the secondary tank drain 84 is also depicted in FIG. 22 along with the primary tank drain containing weep drain cover 74.

Among the features of side jamb 40-2 depicted in FIG. 22 are exterior side jamb surface 48-2, nailing flange 42-2 and top edge 45-2 of the notch formed in the side jamb interior surface as described herein.

FIG. 22 also depicts an end of the sill stop 30 located within the notch formed in side jamb 40-2, with the sill stop 30 being positioned such that its upper edge 32 nests into or abuts the top edge 45-2 of the notch formed in side jamb 40-2.

The various components used in the fenestration unit frames described herein may be constructed of any suitable material or combination of materials including polymers, metals, composites, wood, ceramics, etc. The particular materials used need only perform the functions of the various components as described herein and suitable choices for the materials will be known to those of skill in the art.

The complete disclosure of the patents, patent documents, and publications identified herein are incorporated by reference in their entirety as if each were individually incorporated. To the extent there is a conflict or discrepancy between this document and the disclosure in any such incorporated document, this document will control.

Illustrative embodiments of the fenestration unit frames and related methods are discussed herein with some possible variations described. These and other variations and modifications in the invention will be apparent to those skilled in the art without departing from the scope of the invention, and it should be understood that this invention is not limited to the illustrative embodiments set forth herein. Accordingly, the invention is to be limited only by the claims provided below and equivalents thereof. It should also be understood that this invention also may be suitably practiced in the absence of any element or elements not specifically disclosed as necessary herein.

1. A fenestration unit frame for a fenestration unit, the fenestration unit frame comprising:
a sill member comprising a first sill end and a second sill end, wherein a sill axis extends between the first sill end and the second sill end, wherein the sill member comprises an interior sill face proximate an interior side of the fenestration unit frame and an exterior sill face on an exterior side of the fenestration unit frame, wherein the interior sill face and the exterior sill face are separated from each over a depth of the fenestration unit frame along an interior/exterior axis of the fenestration unit frame;
a first side jamb comprising a first side jamb end attached to the first sill end at a first mitered frame joint, wherein the first side jamb comprises a first side jamb interior face and a first side jamb exterior face, wherein the first side jamb interior face and the first side jamb exterior face are separated from each along the interior/exterior axis, and wherein the first mitered frame joint comprises a welded joint between the first side jamb end and the first sill end;
a second side jamb comprising a second side jamb end attached to the second sill end at a second mitered frame joint, wherein the second side jamb comprises a second side jamb interior face and a second side jamb exterior face, wherein the second side jamb interior face and the second side jamb exterior face are separated from each along the interior/exterior axis, and wherein the second mitered frame joint comprises a welded joint between the second side jamb end and the second sill end;
a sill stop attached to the interior face of the sill member, the sill stop comprising an upper edge and a lower edge extending between the first side jamb and the second side jamb, wherein the upper edge of the sill stop is aligned with the sill axis and located above a top edge of the sill member between the first side jamb and the second side jamb, and wherein the lower edge of the sill stop is located below the top edge of the sill member between the first side jamb and the second side jamb such that the sill stop forms a dam above the sill member between the first side jamb and the second side jamb;
a first jamb notch formed into the first side jamb interior face proximate the first side jamb end, wherein the first jamb notch comprises a first exposed notch face located between a first notch top edge and the first side jamb end, wherein the first exposed notch face is inset from the first side jamb interior face, and wherein a first end portion of the sill stop occupies the first jamb notch such that the upper edge of the sill stop faces the top edge of the first jamb notch; and
a second jamb notch formed into the second side jamb interior face proximate the second side jamb end, wherein the second jamb notch comprises a second exposed notch face located between a second notch top edge and the second side jamb end, wherein the second exposed notch face is inset from the second side jamb interior face, and wherein a second end portion of the sill stop occupies the second jamb notch such that the upper edge of the sill stop faces the top edge of the second jamb notch.

2. A fenestration unit frame according to claim 1, wherein the first end portion of the sill stop covers at least a portion of an interior edge of the first mitered frame joint, and wherein the second end portion of the sill stop covers at least a portion of an interior edge of the second mitered frame joint.

3. A fenestration unit frame according to claim 1, wherein the first end portion of the sill stop covers an interior edge of the first mitered frame joint from an inside corner of the first mitered frame joint to an outside corner of the first mitered frame joint, and wherein the second end portion of the sill stop covers an interior edge of the second mitered frame joint from an inside corner of the second mitered frame joint to an outside corner of the second mitered frame joint.

4. A fenestration unit frame according to claim 1, wherein the upper edge of the sill stop is aligned with the top edge of the first jamb notch.

5. A fenestration unit frame according to claim 1, wherein the sill stop comprises a sill stop interior face facing away from the sill member, wherein the sill stop interior face, the first side jamb interior face, and the second side jamb interior face are all coplanar with each other on the interior side of the fenestration unit frame.

6. A fenestration unit frame according to claim 1, wherein the first end portion of the sill stop covers the first exposed notch face of the first side jamb between the top edge of the first jamb notch and the interior edge of the first mitered frame joint;
and wherein the second end portion of the sill stop covers the second exposed notch face of the second side jamb between the top edge of the second jamb notch and the interior edge of the second mitered frame joint.

7. A fenestration unit according to claim 1, wherein the fenestration unit frame comprises a seal located between the sill stop and the interior sill face, wherein a first end section of the seal is located between the first end portion of the sill stop and the first exposed notch face in the first notch of the first side jamb, and wherein a second end section of the seal is located between the second end portion of the sill stop and the second exposed notch face in the second notch of the second side jamb.

8. A fenestration unit frame according to claim 7, wherein the first end section of the seal is located above the top edge of the sill member in the first exposed notch face of the first side jamb, and wherein the second end section of the seal is located above the top edge of the sill member in the second exposed notch face of the second side jamb and the top edge of the sill member.

9. A fenestration unit frame according to claim 1, wherein the sill member comprises:
a trough located between the interior sill face and the exterior sill face, the trough extending from the first sill end to the second sill end;
a primary containment tank located in the sill member below the trough;
a trough drain configured to drain water in the trough into the primary containment tank;
a primary exterior drain in the sill member, the primary exterior drain configured to drain water in the primary containment tank to the exterior side of the fenestration unit frame;
a secondary containment tank located in the sill member, the secondary containment tank located between the trough and the exterior sill face; and
a secondary exterior drain in the sill member, the secondary exterior drain configured to drain water in the secondary containment tank to the exterior side of the fenestration unit frame.

10. A fenestration unit frame according to claim 9, wherein the primary containment tank and the secondary containment tank are fluidically isolated from each other within the sill member.

11. A fenestration unit frame according to claim 9, wherein the secondary containment tank is located above the primary containment tank in the sill member.

12. A fenestration unit frame according to claim 9, wherein the secondary exterior drain is located above the primary exterior drain.

13. A fenestration unit frame according to claim 9, wherein the sill member comprises an upper exterior surface located between the trough and the exterior face of the sill member, wherein the upper exterior surface of the sill member meets the first side jamb proximate the first sill end at a first exterior sill-side jamb junction, wherein the upper exterior surface of the sill member meets the second side jamb proximate the second sill end at a second exterior sill-side jamb junction, wherein water passing through the first exterior sill-side jamb junction enters the secondary containment tank, and wherein water passing through the second exterior sill-side jamb junction enters the secondary containment tank.

14. A method of constructing a fenestration unit frame, the method comprising:
welding a first sill end of a sill member to a first side jamb end of a first side jamb to form a first mitered frame joint at a first corner of the fenestration unit frame;
welding a second sill end of the sill member to a second side jamb end of a second side jamb to form a second mitered frame joint at a second corner of the fenestration unit frame;
removing a first notch portion of the first side jamb from the first side jamb, wherein the removing forms a first jamb notch in a first side jamb interior face of the first side jamb proximate the first side jamb end, wherein the first jamb notch comprises a first exposed notch face located between a first notch top edge and the first side jamb end, wherein the first exposed notch face is inset from the first side jamb interior face;
removing a second notch portion of the second side jamb from the second side jamb, wherein the removing forms a second jamb notch in a second side jamb interior face of the second side jamb proximate the second side jamb end, wherein the second jamb notch comprises a second exposed notch face located between a second notch top edge and the second side jamb end, wherein the second exposed notch face is inset from the second side jamb interior face; and
attaching a sill stop to the fenestration unit frame, wherein the sill stop is positioned over an interior sill face of the sill member such that a first end portion of the sill stop is located over the first exposed notch face of the first jamb notch and a second end portion of the sill stop is located over the second exposed notch face of the second jamb notch.

15. A method according to claim 14, wherein the removing the first notch portion comprises removing the first notch portion before welding the first sill end of the sill member to the first side jamb end of the first side jamb to form the first mitered frame joint.

16. A method according to claim 14, wherein the removing the first notch portion comprises removing the first notch portion after welding the first sill end of the sill member to the first side jamb end of the first side jamb to form the first mitered frame joint.

17. A method according to claim 14, wherein the sill stop comprises an upper edge located above a top edge of the sill member, and wherein, after attaching the sill stop to the fenestration unit frame, the upper edge of the sill stop in the first end portion of the sill stop faces the top edge of the first jamb notch and the upper edge of the sill stop in the second end portion of the sill stop faces the top edge of the second jamb notch.

18. A method according to claim 14, wherein, after attaching the sill stop to the fenestration unit frame, the upper edge of the sill stop is aligned with the top edge of the first jamb notch.

19. A method according to claim 14, wherein, after attaching the sill stop to the fenestration unit frame, the first end portion of the sill stop covers at least a portion of an interior edge of the first mitered frame joint in the first exposed notch face, and the second end portion of the sill stop is located in the second jamb notch and covers at least a portion of an interior edge of the second mitered frame joint in the second exposed notch face.

20. A method according to claim 19, wherein the first end portion of the sill stop covers the interior edge of the first mitered frame joint from an inside corner of the first mitered frame joint to an outside corner of the first mitered frame joint, and wherein the second end portion of the sill stop covers the interior edge of the second mitered frame joint from an inside corner of the second mitered frame joint to an outside corner of the second mitered frame joint.

21. A method according to claim 14, wherein the fenestration unit frame comprises a seal located between the sill stop and the interior sill face, wherein, after attaching the sill stop to the fenestration unit frame, a first end section of the seal is located between the first end portion of the sill stop and the first exposed notch face in the first notch of the first side jamb, and a second end section of the seal is located between the second end portion of the sill stop and the second exposed notch face in the second notch of the second side jamb.

22. A method according to claim 21, wherein the first end section of the seal is located above the top edge of the sill member in the first exposed notch face of the first side jamb, and wherein the second end section of the seal is located above the top edge of the sill member in the second exposed notch face of the second side jamb and the top edge of the sill member.

23. A method according to claim 21, wherein the sill stop comprises an upper edge located above a top edge of the sill member, and wherein the first end section of the seal comprises a first terminal seal end located closer to the upper edge of the sill stop than the bottom edge of the sill stop, and wherein the second end section of the seal comprises a second terminal seal end located closer to the upper edge of the sill stop than the bottom edge of the sill stop.

24. A method according to claim 14:
wherein the sill member comprises:
a trough located between the interior sill face and an exterior sill face on an exterior side of the fenestration unit frame, wherein the interior sill face and the exterior sill face are separated from each over a depth of the fenestration unit frame along an interior/exterior axis of the fenestration unit frame, the trough extending from the first sill end to the second sill end;
a primary containment tank located in the sill member below the trough;
a trough drain configured to drain water in the trough into the primary containment tank;
a primary exterior drain in the sill member, the primary exterior drain configured to drain water in the primary containment tank to the exterior side of the fenestration unit frame;
a secondary containment tank located in the sill member, the secondary containment tank located between the trough and the exterior sill face; and
a secondary exterior drain in the sill member, the secondary exterior drain configured to drain water in the secondary containment tank to the exterior side of the fenestration unit frame;
wherein welding the first sill end of the sill member to the first side jamb end of the first side jamb to form the first mitered frame joint at the first corner of the fenestration unit frame and welding the second sill end of the sill member to the second side jamb end of the second side jamb to form the second mitered frame joint at the second corner of the fenestration unit frame forms the primary containment tank and the secondary containment tank.

25. A method according to claim 24, wherein the primary containment tank and the secondary containment tank are fluidically isolated from each other within the sill member.

26. A method according to claim 24, wherein the sill member comprises an upper exterior surface located between the trough and the exterior face of the sill member, wherein the upper exterior surface of the sill member meets the first side jamb proximate the first sill end at a first exterior sill-side jamb junction, wherein the upper exterior surface of the sill member meets the second side jamb proximate the second sill end at a second exterior sill-side jamb junction, wherein water passing through the first exterior sill-side jamb junction enters the secondary containment tank, and wherein water passing through the second exterior sill-side jamb junction enters the secondary containment tank.
